(19) United States
(12) Patent Application Publication
(10) Pub. No.: US 2017/0341071 A1
(43) Pub. Date: Nov. 30, 2017

(54) BURETTE

(71) Applicant: MILES BLACKWOOD-SEWELL, Buderim (AU)

(72) Inventor: MILES BLACKWOOD-SEWELL, Buderim (AU)

(21) Appl. No.: 15/403,165

(22) Filed: Jan. 10, 2017

(30) Foreign Application Priority Data
May 27, 2016 (AU) 2018203528

(51) Int. Cl. B01L 3/02; F16K 31/02

(52) U.S. Cl. CPC B01L 3/02; F16K 31/02

(57) ABSTRACT

A sliding seal [4] is operated within a bore [1] by means of magnetic attraction to an externally positioned and operated ring magnet [10] thus enabling a burette to be filled through the jet [3] like a syringe and remove the need for a control tap.

A laboratory burette is a gravity drain liquids dispensing device commonly used in titrations. Its form is usually long and slender, made of glass or plastic, marked with graduations, the upper end being open and the lower end provided with a control valve. The burette is held vertically in a separate stand. To fill the burette, liquid is either poured in the top open end with the aid of a funnel or pumped into the top of the burette from a squeezy reservoir bottle.

Burettes suffer from disadvantages in that they are fragile by nature of their slender shape, are awkward and time consuming to precondition prior to use, and spills are easily sustained when filling with a funnel. Good laboratory practise requires preconditioning of the equipment to prevent contamination of analytical results. Preconditioning is a process whereby the internal walls of the burette are flushed three times with a small amount of the liquid to be used. During the preconditioning process the burette is held almost horizontally and rolled to ensure the flushing fluid covers all the walls of the burette a process that can lead to inadvertent spills from the top open end of the burette. Additionally, the bottom control valve is prone to leakage and air bubbles often form in this area leading to inaccurate measurement. The condition of the bore wall will affect the volume dispensed, as will the viscosity and volatility of the fluid being dispensed. These disadvantages are amplified in the classroom environment where users are relatively inexperienced. It is thus a general object of the present invention to overcome, or at least ameliorate, one or more of the above mentioned disadvantages.

The present invention overcomes the disadvantages of prior burettes by providing an method of fluid control which simplifies preconditioning, filling, dispensing and cleaning. In the present invention, the troublesome valve is not needed and the total length of the burette can be shortened. In this way the burette of the present invention is safer, quicker, more convenient to operate and more robust.

According to one aspect of the present invention, there is provided a device for dispensing liquids, said device including a tubular body wherein a sliding seal forms an hydraulic lock such that when the lower end of the tubular body is immersed in fluid and the seal is drawn upwards fluid is drawn into the tubular body through the lower end of the said body wherein the said seal movement is achieved by application of a magnetic force. Preferably the magnetic force is provided by an external ring magnet operating against at least one magnet placed within the glass tube and suitably joined to the seal such that the seal moves in relation to the motion of the external magnet The magnets may be protected from the chemical environment by a suitable plastics coating such as one from the polytetrafluoroethylene family.

The seal may be adjustable in diameter to allow for slight variations in glass diameter, and completely removable from the tubular body for purposes of adjustment and cleaning.

Errors in precision happen with gravity drain burettes because the condition on the surface of the burette bore wall, or the viscosity or volatility of the fluid itself, cause varying amounts of fluid to adhere to the bore wall when dispensing. This problem is removed in the present invention due to its positive displacement action where the fluid displaced is according to the movement of the seal, with minimal residual fluid remaining on the bore wall.

To avoid damage to the glass at the top end of the tube while the seal is being inserted and removed, a section of plastics tube may provide protection at this point.

If the burette is not be used for an extended period, for example two days, and still has fluid within the body, a device may optionally be installed on the bottom of the tube to stop fluid dripping or a bung placed in the top of the burette to reinforce the hydraulic lock.

The magnets may operate a valve with a seating arrangement, for example the magnet may operate the needle of a needle valve arrangement, however a preferred embodiment of the invention will now be described with reference to the accompanying drawing, wherein;

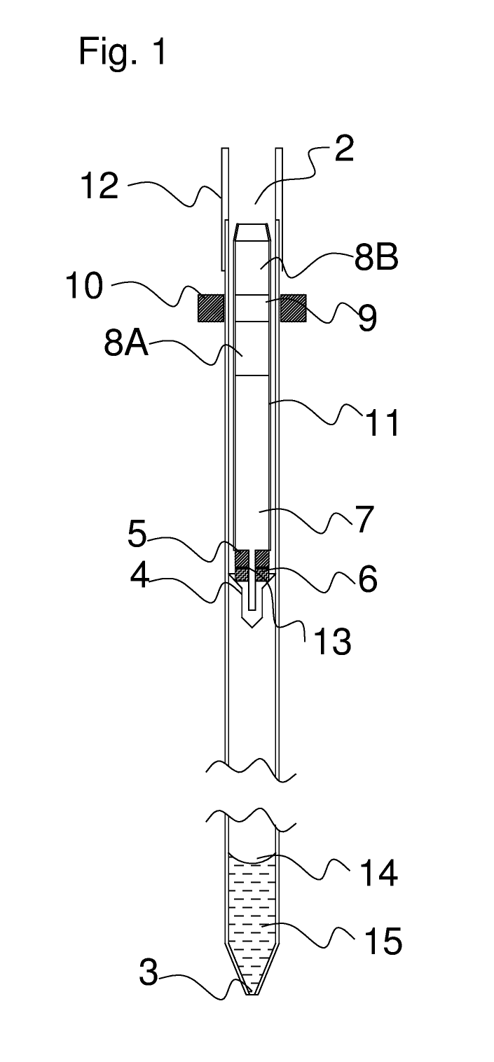

FIG. 1 illustrates in cross-sectional view a burette according to the present invention.

With reference to FIG. 1, a tubular glass body [1] is equipped with an open end [2] and an opposite end formed into a jet [3]. Seal [4] runs inside tube [1] and is adjusted in diameter by screwing the knurled nut [5] against rubber insert [6] thus pressurizing and expanding rubber insert [6] and seal [4] to create an hydraulic seal. Connecting rod [7] is threaded into the top of seal [4] and disengagingly joins the seal body [4] and knurled nut [5] to two magnets [8]. Magnets [8A and 8B] are separated by spacer [9] such that ring magnet [10], external to the glass tube [1], is held magnetically captive between them. The various parts of the assembly are wrapped in PTFE shrink wrap [11] so that they remain as a single unit when removed from the burette bore by sliding out of the open end [2]. Protective tube [12] protects the glass at open end [2] from damage caused by the strong attraction between the magnets [8A and 8B] and [10] when removing the internal assembly from the bore of tube [1]. Preferably mark [13] is provided to measure fluid dispensed according to movement of the seal, thus substantially reducing parallax error compared with reading the meniscus [14].

To operate the burette, ring magnet [10] is moved up and down glass tube [1] to push or pull the captive magnets [8A and 8B] causing the seal [4] to move. The hydraulic vacuum created by movement of seal [4] causes the fluid [15] to be aspirated and dispensed according to movement of ring magnet [10]. The burette is preferably preconditioned by aspirating a small amount of the fluid to be used, inverting the burette and drawing up the seal to wet all parts of the internal walls, and dispensing the fluid to waste. When preconditioning equipment of the present invention in this way, no filling funnel is needed and there is no chance of accidental spills either when filling or when rolling the burette horizontally to wet the walls of the burette because exit of the fluid is prevented by the seal [4]. After preconditioning, the burette of the present invention is filled either after it is clamped into a burette stand or before clamping. The jet is immersed into the liquid and then the external magnet [10] is moved upward to fill the burette, thus filling without the need of a funnel and eliminating spills.

The heretofore described device thus at least ameliorates the disadvantages of prior burettes. The construction and shape of the present device renders it less likely to break compared with prior burettes which have long very slender valve sections. Filling from the top with a funnel is not required and a more thorough cleaning and pre-conditioning action is achieved. The combination of tapered jet and hydraulic seal holds fluids for days without dripping and so a control valve is not needed, thus eliminating a source of leaks, air bubbles and breakage.

Thus is provided a controlling device which renders the burette less prone to breakage, safer, faster and more convenient in use.

It will be appreciated that the above described embodiment is only an exemplification of the various aspects of the present invention and that modifications and alterations can be made thereto without departing from the inventive concept.

1. A liquids dispensing device, said device including:
a body having an internal bore;
a seal operating within said bore; and
a means for controlling the operation of the seal magnetically.

2. A liquids dispensing device, said device including:
a body having an internal bore;
a seal operating with a sliding motion within said bore; and
a means for operating said sliding motion magnetically.

3. A liquids dispensing device as in claim 2 wherein the bore is within a graduated glass tube.

4. A liquids dispensing device as in claim 2 or claim 3 wherein at least one magnet is external to the bore and operated manually by direct application of hand pressure.

5. A liquids control device, said device including:
provision for attachment of a seal
provision of at least one section specifically for magnetic interaction
wherein the parts are arranged for insertion into a tube

6. A method of moving a sliding seal within a bore magnetically whereby a magnet external to the bore applies magnetic force to internal elements causing them to move within the bore.
